(19) United States
(12) Patent Application Publication
(10) Pub. No.: US 2023/0297005 A1
(43) Pub. Date: Sep. 21, 2023

(54) IMAGE FORMING APPARATUS

(71) Applicant: KYOCERA Document Solutions Inc., Osaka (JP)

(72) Inventor: Takashi INOUE, Osaka-shi (JP)

(73) Assignee: KYOCERA Document Solutions Inc., Osaka (JP)

(21) Appl. No.: 18/158,352

(22) Filed: Jan. 23, 2023

(30) Foreign Application Priority Data
Jan. 24, 2022 (JP) 2022-008878

(51) Int. Cl. G03G 15/08

(52) U.S. Cl. CPC G03G 15/0856; G03G 15/0865

(57) ABSTRACT

Storage stores therein a printing rate and an ideal developer supply amount of a developer to be supplied to a development device. The ideal developer supply amount is determined according to the printing rate. A developer amount detection section detects the amount of the developer in the development device. A supply amount detection section detects an actual developer supply amount by detecting the amount of the developer supplied by the developer supply section. A comparison section compares the actual development supply amount with the ideal developer supply amount and outputs first comparison information indicating a result of comparison. An adjusting section adjusts the actual developer supply amount of the developer supply section based on the first comparison information.

### INCORPORATION BY REFERENCE

The present application claims priority under 35 U.S.C. §119 to Japanese Patent Application No. 2022-008878, filed on Jan. 24, 2022. The contents of this application are incorporated herein by reference in their entirety.

### BACKGROUND

The present disclosure relates to an image forming apparatus.

Typically, development of an image forming apparatus that periodically performs calibration is promoted.

### SUMMARY

According to an aspect of the present disclosure, an image forming apparatus includes a development device, a power source, storage, a developer supply section, a developer amount detection section, a supply amount detection section, a comparison section, and an adjusting section. The development device develops an electrostatic latent image formed on a photosensitive member with a developer. The power source applies a voltage to the development device. The storage stores therein a printing rate and an ideal developer supply amount of the developer to be supplied to the development device. The ideal developer supply amount is determined according to the printing rate. The developer supply section supplies the developer to the development device. The developer amount detection section detects an amount of the developer in the development device. The supply amount detection section detects an actual developer supply amount by detecting an amount of the developer supplied by the developer supply section. The comparison section performs comparison of the actual developer supply amount with the ideal developer supply amount and outputs first comparison information indicating a result of the comparison. The adjusting section adjusts based on the first comparison information the voltage that the power source applies.

### BRIEF DESCRIPTION OF THE DRAWINGS

FIG. 1 is a diagram illustrating the configuration of an image forming apparatus according to an embodiment.

FIG. 2 is a block diagram of the configuration of the image forming apparatus according to the embodiment.

FIG. 3 is a diagram illustrating comparison between ideal developer supply amount and actual developer supply amount in the image forming apparatus according to the embodiment.

FIG. 4 is a diagram illustrating comparison between the ideal developer supply amount and the actual developer supply amount in the image forming apparatus according to the embodiment.

FIG. 5 is a flowchart depicting control of the image forming apparatus according to the embodiment.

### DETAILED DESCRIPTION

The following describes an image forming apparatus 1 according to an embodiment of the present disclosure with reference to the accompanying drawings. Note that elements that are the same or equivalent are indicated by the same reference signs in the drawings and description thereof is not repeated.

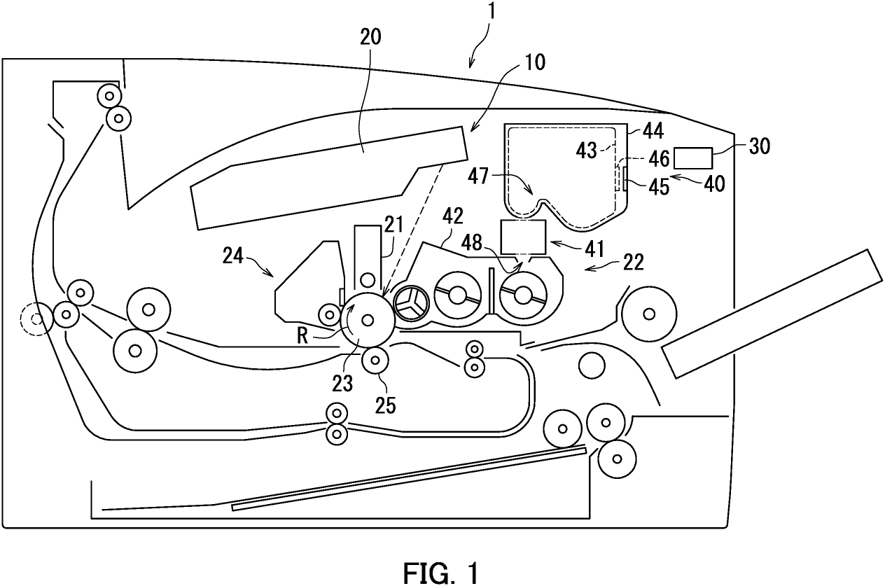

The configuration of the image forming apparatus 1 according to the resent embodiment will be described first with reference to FIG. 1. FIG. 1 is a diagram illustrating the configuration of the image forming apparatus 1 according to the present embodiment. The image forming apparatus 1 is a copier, a printer, a facsimile machine, or a multifunction peripheral having all the functions of then, for example.

The image forming apparatus 1 forms an image on a sheet based on image data. Examples of the sheet include a sheet of paper and an overhead projector (OHP) sheet. The OHP sheet is a transparent film with a text or a figure drawn thereon that is used for an overhead projector.

The image forming apparatus 1 may be installed in a company office, a government office, a school, or a factory, for example.

As illustrated in FIG. 1, in a case in which the image forming apparatus 1 is an electrographic image forming apparatus, the image forming apparatus 1 includes a sheet feed section, a conveyance section, an image forming section 10, a fixing section, an ejection section, and a controller 30. While in a case in which the image forming apparatus 1 is an electrographic image forming apparatus, the image forming apparatus 1 includes a fixing section. In a case in which the image forming apparatus 1 is an inkjet image forming apparatus, the fixing section can be dispensed with.

The sheet feed section includes a sheet feed cassette and a sheet feed roller group. The sheet feed cassette accommodates a plurality of sheets. The sheet feed roller group feeds the sheets accommodated in the sheet feed cassette one at a time. Examples of the sheets include paper-made sheets and synthetic resin-made sheets.

The conveyance section includes a plurality of conveyance rollers that form a conveyance path, at least one guide member, and an exit tray. Each of the sheets is guided by the guide member and conveyed through the conveyance path by the conveyance rollers. The sheet is conveyed from the sheet feed section to the ejection section via the image forming section 10 and the fixing section. The sheet is ejected onto the exit tray by the ejection section.

The image forming section 10 includes a light exposure section 20, a charger 21, a development device 22, a photosensitive member 23, a cleaner 24, and a transfer roller 25. Each of the light exposure section 20, the charger 21, the development device 22, the photosensitive member 23, and the transfer roller 25 may be referred to as development functional element.

The charger 21, the development device 22, the transfer roller 25, and the cleaner 24 are arranged along the circumferential surface of the photosensitive member 23.

The light exposure section 20 generates an electrostatic latent image on the photosensitive member 23 based on image data. A later-described high voltage substrate 50 (power source 50) applies a voltage to the light exposure section 20 to drive the light exposure section 20. The light exposure section 20 exposes a photosensitive layer of the photosensitive member 23 to light by laser light irradiation. The light exposure section 20 exposes the photosensitive layer of the photosensitive member 23 based on the image data. As a result, an electrostatic latent image is formed on the photosensitive member 23. The light exposure section 20 includes light emitting diodes (LEDs), for example.

The charger 21 uniformly charges the photosensitive member 23 to a predetermined polarity. A specific example of the charger 21 is a corona discharger.

To the development device 22, a two-component developer containing a magnetic carrier and a developer containing developer particles is loaded, for example.

The developer is a toner in a case in which the image forming apparatus 1 is an electrographic image forming apparatus. The developer is an ink in a case in which the image forming apparatus 1 is an inkjet image forming apparatus. In the following, the developer may be referred to as toner as necessary.

The development device 22 develops with the developer such as a toner the electrostatic latent image formed on the photosensitive member 23 into a developer image. The later-described high-voltage substrate 50 (power source 50) applies a voltage to the development section 22 to drive the development section 22. The photosensitive member 23 is an example of an image bearing member. The cleaner 24 collects developer attached to the surface of the photosensitive member 23.

The transfer roller 25 is disposed opposite to the photosensitive member 23. The transfer roller 25 is moved to and away from the photosensitive member 23 by a non-illustrated drive mechanism. The transfer roller 25 presses the photosensitive member 23 to form a nip. When the sheet passes through the nip, the developer image on the photosensitive member 23 is transferred to the sheet.

The fixing section includes a heating section and a pressure section. The heating section and the pressure section are disposed opposite to each other. The pressure section presses the heating section to form a fixing nip. The sheet with the developer image transferred thereto receives heat and pressure when passing through the fixing nip. As a result, the developer image is fixed to the sheet. The sheet is conveyed to the ejection section from the fixing section by the conveyance section.

The ejection section includes an ejection roller pair and an exit tray. The ejection roller pair ejects the sheet onto the exit tray. The exit tray is formed on the top of the image forming apparatus 1, for example.

In a case in which the image forming apparatus 1 is an inkjet printer, the image forming section 10 includes ink cartridges, ink tanks, a pump, heads, nozzles, electrodes, and a conveyor belt.

The ink cartridges and the ink tanks each reserve a water-based ink in a corresponding one of colors of yellow, magenta, cyan, and black.

The pump supplies the inks from the ink tanks to the heads.

Multiple nozzles each corresponding to a pixel are formed in the head. The inks in colors corresponding to image data are supplied to the head from the ink tanks based on the image data. The inks are ejected from the nozzles toward the sheet.

The electrodes include a charging electrode and a deflection electrode, for example. The charging electrode charges the inks ejected from the nozzles. The deflection electrode controls a direction in which the charged inks are ejected.

The conveyor belt is disposed opposite to the nozzles of the head and conveys the sheet. The inks ejected from the nozzles in the heads form an image on the sheet being conveyed by the conveyor sheet.

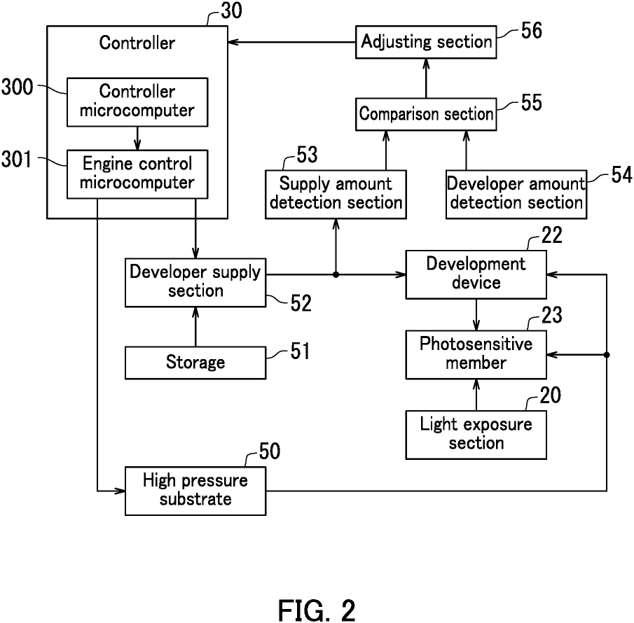

The controller 30 controls operation of each element of the image forming apparatus 1. The controller 30 will be described also with reference to FIG. 2.

The controller 30 is a processor such as a central processing unit (CPU), for example. The controller 30 may be an integrated circuit such as a system-on-a-chip (SoC) for implementing all the functions of the elements. The controller 30 may be constituted by a combination of a plurality of integrated circuits. The controller 30 performs overall control of operation of the image forming apparatus 1 to implement each function.

The development device 22 of the image forming section 10 will be described next in detail. The development device 22 includes a developer supply section 40, an accommodation section 41, and a developing section 42.

The developer supply section 40 supplies the developer reserved in a developer container 43 to the accommodation section 41. The developer supply section 40 includes the developer container 43, a fitting section 44, and a reading device 45. The developer container 43 is fitted in the fitting section 44.

The developer container 43 reserves the developer in a reservoir space in the interior thereof. In the present embodiment, the developer container 43 replenishes the image forming section 10 with a black developer, for example. The developer container 43 includes a storage element 46 and a first supply port 47. The developer reserved in the developer container 43 is supplied to the accommodation section 41 through the first supply port 47.

At least information indicating a value of the weight of the developer when the developer is full is stored in the storage element 46. When a user attaches the developer container 43 into the fitting section 44, the reading device 45 reads the information stored in the storage element 46 to recognize the value of the weight of the developer reserved in the developer container 43.

The storage element 46 may further store therein information indicating the shape of the developer container 43, information about the color of the developer, information on date of manufacture, and information indicating a value of the weight of the developer in a state in which the developer container 43 is being attached to the fitting section 44. In the present embodiment, the storage element 46 is a radio frequency (RF) tag, for example, and the reading device 45 is a RF reader, for example.

The accommodation section 41 accommodates the developer supplied from the developer container 43. The accommodation section 41 is a bottomed box-shaped member. The developer supplied to the accommodation section 41 is loaded into the developing section 42 through a second supply port 48. The capacity of the accommodation section 41 is preferably smaller than the capacity of the developer container 43. As a result of the capacity of the accommodation section 41 being set to be smaller than the capacity of the developer container 43, the space occupied by the accommodation section 41 can be reduced.

The developing section 42 supplies the developer loaded from the accommodation section 41 to the photosensitive member 23.

The configuration of the image forming apparatus 1 will be described further in detail next with reference to FIG. 2.

As illustrated in FIG. 2, the image forming apparatus 1 includes a high-voltage substrate 50 (power source 50), storage 51, a developer supply section 52 (developer supply section 40), a supply amount detection section 53, a developer amount detection section 54, a comparison section 55, and an adjusting section 56 in addition to the light exposure section 20, the photosensitive member 23, the development device 22, and the controller 30 which have been described with reference to FIG. 1. In the following, the high-voltage substrate 50 may be referred to as power source 50. The developer supply section 52 may be the developer supply section 40.

The controller 30 includes a controller microcomputer 300, and an engine control microcomputer 301.

The controller microcomputer 300 outputs an image formation instruction to the engine control microcomputer 301. The controller microcomputer 300 may output information indicating a printing rate to the engine control microcomputer 301.

In each of the controller microcomputer 300 and the engine control microcomputer 301, a microprocessor is used as a CPU, and a peripheral circuit and small memory are embedded in a single chip, for example.

The engine control microcomputer 301 outputs to the power source 50 an instruction for high-voltage application.

The power source 50 applies a voltage at a frequency indicated in an application signal to the development device 22 and the photosensitive member 23. The power source 50 may apply a high voltage to the light exposure section 20. Alternatively, the power source 50 may apply a high voltage to any or all of the development functional elements.

The engine control microcomputer 301 further outputs to the developer supply section 52 information indicating a developer supply amount.

The storage 51 stores therein a printing rate and an ideal developer supply amount of the developer that is to be supplied to the development device 22 and that is determined according to the printing rate.

The printing rate is a ratio of a cumulative area of images formed on sheets to the total area of the sheets, for example.

Upon receiving an image formation instruction from the controller microcomputer 300, the engine control microcomputer 301 outputs an instruction for high-voltage application to the power source 50. At that time, the developer supply section 52 supplies the developer to the developing section 42 while a non-illustrated sensor monitors the amount of the developer in the developing section 42 to keep the amount of the developer in the developing section 42 constant.

The sensor may be a magnetic permeability sensor, for example. The magnetic permeability sensor detects a concentration of the developer (amount of developer) by measuring the magnetic permeability of charged developer.

The ideal developer supply amount is an ideal amount of the developer that is to be supplied to the developing section 42 from the developer supply section 52 when the developer in an amount determined according to a specific printing rate is supplied from the development device 22 to the photosensitive member 23.

When the developer of which amount is determined according to the specific printing rate is supplied from the developing section 42 to the photosensitive member 23, the ideal developer supply amount of the developer is supplied to the developing section 42 from the developer supply section 52, thereby keeping the amount of the developer in the developing section 42 constant.

The developer supply section 52 supplies the developer to the development device 22.

However, it is probable that the ideal supply amount of the developer is not supplied from the developer supply section 52 due to some cause in any of the light exposure section 20, the development device 22, and the photosensitive member 23, for example. In other words, the amount of the developer actually supplied from the developer supply section 52 may deviate from the ideal developer supply amount due to some cause in the light exposure section 20, the photosensitive member 23, or any other development functional elements.

The developer amount detection section 54 detects the amount of the developer in the development device 22. The developer amount detection section 54 may detect the concentration of the developer in the development device 22.

The supply amount detection section 53 detects the actual developer supply amount by detecting the amount of the developer that the developer supply section 52 has supplied. The supply amount detection section 53 may detect the actual developer supply amount by detecting the concentration of the developer in the development device 22.

The actual developer supply amount is an amount of the developer (concentration of the developer) actually supplied to the development device 22 from the developer supply section 52.

The comparison section 55 compares the actual developer supply amount with the ideal developer supply amount and outputs first comparison information indicating a difference between the ideal developer supply amount and the actual developer supply amount.

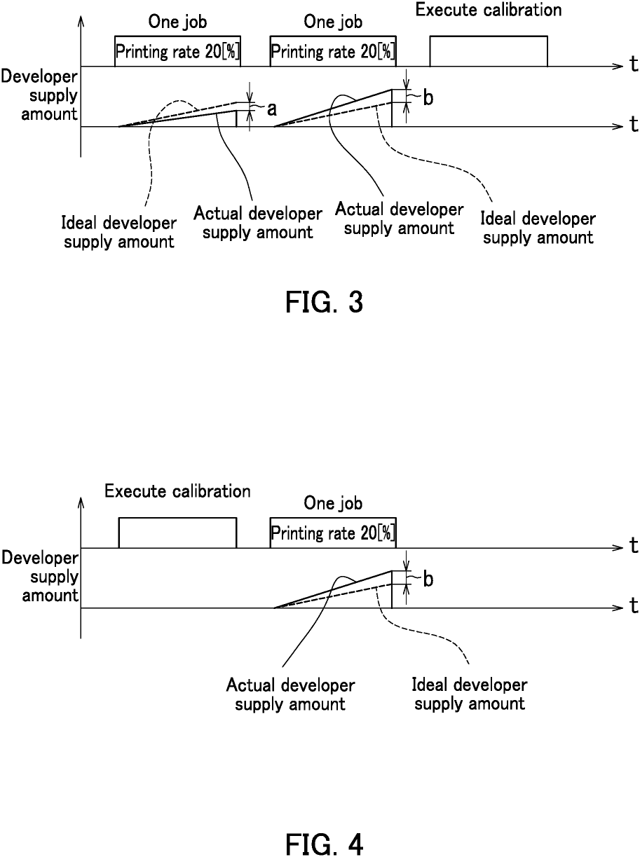

Here, description is made about job timing and adjustment of the voltage applied by the power source 50 with reference to FIG. 3.

In the upper part in FIG. 3, the vertical axis indicates developer supply amounts while the horizontal axis indicates time. In the upper part in FIG. 3, two jobs each for image formation at a printing rate of 20% are executed, for example.

In the lower part in FIG. 3, the vertical axis indicates the developer supply amounts while the horizontal axis indicates time. The dashed lines in the lower part in FIG. 3 indicate change in the ideal developer supply amount. The solid lines in the lower part in FIG. 3 indicate change in the actual developer supply amount.

The comparison section 55 may compare the actual developer supply amount with the ideal developer supply amount at the end of each job and outputs the first comparison information.

In the lower part in FIG. 3, the actual developer supply amount is accumulated as the processing of the first job indicated in the upper part in FIG. 3 proceeds. The reference sign a indicates a difference between the ideal developer supply amount and the actual developer supply amount indicated in the lower part in FIG. 3 at the time when the processing of the first job indicated in the upper part in FIG. 3 ends. At that time, a is 5%, for example.

The comparison section 55 compares the actual developer supply amount with the ideal developer supply amount at the time when the processing of the first job ends, and outputs the first comparison information indicating that the difference a is 5%.

The comparison section 55 may further compare the difference a, which is 5%, with a threshold value and outputs the first comparison information additionally indicating the result of further comparison. The threshold value is 10%, for example. In this case, the first comparison information output from the comparison section 55 indicates that the difference a is greater than the threshold value.

The adjusting section 56 adjusts the voltage that the power source 50 is to apply based on the first comparison information.

When the first comparison information indicates that the difference a is no greater than the threshold value, the adjusting section 56 may not adjust the voltage that the power source 50 is to apply. In other words, so-called calibration, which will be described later, may not be executed.

The reference sign b indicates a difference between the ideal developer supply amount and the actual developer supply amount indicated in the lower part in FIG. 3 at the time when the processing of the second job indicated in the upper part in FIG. 3 ends. At that time, b is 12%, for example.

Next, the comparison section 55 compares the actual developer supply amount with the ideal developer supply amount at the time when the second job indicated in the upper part in FIG. 3 ends, and outputs the first comparison information indicating that the difference b is 12%.

The comparison section 55 may further compare the difference b, which is 12%, with the threshold value, which is 10%, and outputs the first comparison information. In this case, the first comparison information output from the comparison section 55 indicates that the difference b is greater than the threshold value.

The adjusting section 56 executes so-called calibration as illustrated in the upper part in FIG. 3.

Specifically, in calibration, a sensor disposed near a contact part (second transfer part) where the sheet comes into contact with the transfer roller 25 (FIG. 1) senses whether or not image formation has been done at a printing rate of 20%. When the sensor senses that image formation at a printing rate of 20% has not been done, the engine control microcomputer 301 controls the power source 50 to adjust the high voltage to be applied to the development device 22 and the photosensitive member 23 so that the printing rate reaches 20%.

According to the present embodiment, the voltage applied the development device 22 can be adjusted as necessary according to comparison of the actual developer supply amount with the ideal developer supply amount.

In the present embodiment, the comparison section 55 outputs the first comparison information as a result of comparison of the actual developer supply amount with the ideal developer supply amount each time a job ends. Accordingly, whether or not calibration is necessary can be determined each time a job ends.

The adjusting section 56 may adjust the voltage only when the first comparison information indicates that the difference between the ideal developer supply amount and the actual developer supply amount is greater than a specific value.

That is, in the example illustrated in FIG. 3, the adjusting section 56 may execute calibration only when the first comparison information is output that indicates that the difference b is 12% as a result of comparison by the comparison section 55 between the ideal developer supply amount and the actual developer supply amount at the time when the second job illustrated in the upper part in FIG. 3 ends.

Typically, an image forming apparatus executes calibration periodically. This means that unnecessary calibration is repeated.

According to the present embodiment, calibration is executed only when necessary, thereby achieving reduction in unnecessary power consumption and unnecessary execution of control.

Further description is made about job timing and voltage adjustment with reference to FIG. 4 next to FIG. 3.

In the upper part in FIG. 4, the vertical axis indicates the developer supply amounts while the horizontal axis indicates time. In the upper part in FIG. 4, after calibration described with reference to FIG. 3 is executed, the third job is additionally executed, for example. That is, calibration illustrated in FIG. 4 may be executed in the same manner as calibration illustrated in FIG. 3.

The dashed line in the lower part in FIG. 4 indicates change in the ideal developer supply amount in the third job. The solid line in the lower part in FIG. 4 indicates change in the actual developer supply amount in the third job.

As illustrated in the upper part in FIG. 4, after calibration is executed, the third job is additionally executed by which image formation is performed at a printing rate of 20%.

The comparison section 55 may compare an actual developer supply amount adjusted by the adjusting section 56 with the ideal developer supply amount and output second comparison information.

The actual developer supply amount in the lower part in FIG. 4 accumulates as processing of the third job illustrated in the upper part in FIG. 4 proceeds. The reference sign b indicates a difference between the ideal developer supply amount and the actual developer supply amount indicated in the lower part in FIG. 4 at a time when the processing of the third job indicated in the upper part in FIG. 3 ends. At that time, b is 12%, for example.

The comparison section 55 compares the actual developer supply amount with the ideal developer supply amount at the time when the third job indicated in the upper part in FIG. 4 ends, and outputs second comparison information indicating that the difference b is 12%.

That is, the difference b is 12% as a result of comparison between the ideal developer supply amount and the actual developer supply amount after the third job even after execution of calibration. That is, the difference b is greater than the threshold value of 10%. In this case, it is thought that the amount of the developer supplied from the developer supply section 52 deviates from the ideal developer supply amount due to some cause not from the light exposure section 20 and the photosensitive member 23.

For example, it is thought that the developer may scatter in transfer of the developer from the development device 22 to the photosensitive member 23, from the photosensitive member 23 to a non-illustrated transfer target (in first transfer), or from the transfer target to the sheet (in second transfer).

In this case, it is preferable to take a measure to inhibit developer scattering rather than execution of calibration.

The adjusting section 56 may adjust the actual developer supply amount of the developer supply section 52 based on the second comparison information so as to change the ratio of the developer to the carrier.

Specifically, the development device 22 contains the two-component developer in which the magnetic carrier and the developer formed from resin are mixed. The developer is charged by stirring the carrier and the developer.

As described previously, the magnetic permeability sensor is disposed at the development device 22. The magnetic permeability sensor detects the magnetic permeability of the charged developer.

In one example, a ratio (target toner/carrier (T/C)) of the developer to the carrier in the development device 22 is set to 6%.

As the amount of charge of the developer is decreased, attraction between the developer particles decreases, which may cause developer scattering in detachment of the developer. As such, the adjusting section 56 may perform adjustment to reduce the actual developer supply amount of the developer supply section 52.

The adjusting section 56 may adjust the actual developer supply amount of the developer supply section 52 based on the second comparison information so that the ratio of the developer to the carrier reaches 5%, for example.

As such, friction between the developer particles increases and the amount of charge of the developer increases as the ratio of the developer to the carrier in the development device 22 is deceased. As a result, attraction between the developer particles increases, thereby achieving inhibition of developer scattering in detachment.

According to the present embodiment, adjustment of the target T/C can inhibit developer scattering with a result that the actual developer supply amount can be favorably matched with the ideal developer supply amount.

The adjusting section 56 may further adjust timing of the developer supply section 52 supplying the developer in an adjusted developer supply amount.

In a case in which the target T/C is adjusted periodically, the target T/C may be adjusted with inappropriate timing.

According to the present embodiment, the target T/C is favorably adjusted only when adjustment is necessary, thereby achieving reduction in unnecessary power consumption and unnecessary execution of control.

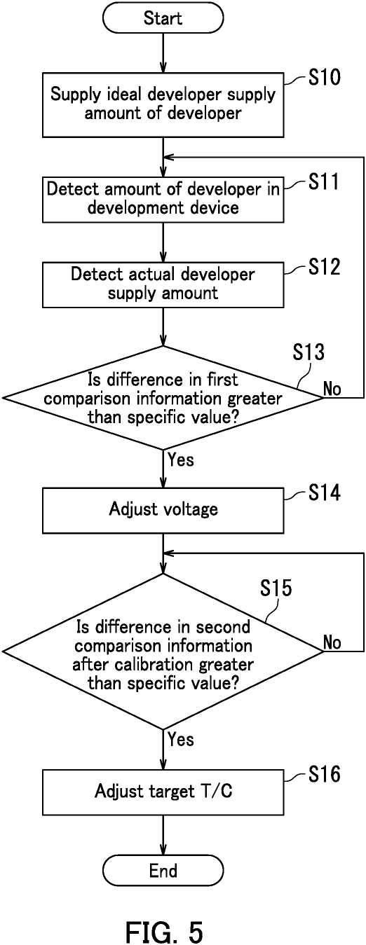

Control of the image forming apparatus 1 will be described next with reference to FIG. 5. FIG. 5 is a flowchart depicting the control of the image forming apparatus 1 according to the present embodiment.

As depicted in FIG. 5, the flowchart includes Steps S10 to S16. Details are as follows.

In Step S10 depicted in FIG. 5, the developer supply section 52 supplies the developer according to the ideal developer supply amount to the development device 22. The routine proceeds to Step S11.

In Step S11, the developer amount detection section 54 detects the amount of the developer in the development device 22. The routine proceeds to Step S12.

In Step S12, the supply amount detection section 53 detects the amount of the developer supplied by the developer supply section 52 to detect the actual developer supply amount. The routine proceeds to Step S13.

In Step S13, the comparison section 55 compares the actual development supply amount with the ideal developer supply amount and outputs the first comparison information. If the difference between the actual developer supply amount and the ideal developer supply amount indicated in the first comparison information is greater than a specific amount set as the threshold value (Yes in Step S13), the routine proceeds to Step S14.

If the difference between the ideal developer supply amount and the actual developer supply amount indicated in the first comparison information is no greater than the specific amount set as the threshold value (No in Step S13), the routine returns to Step S11.

If Yes in Step S13, the adjusting section 56 adjusts the voltage that the power source 50 is to apply based on the first comparison information in Step S14. The routine proceeds to Step S15.

In Step S15, the comparison section 55 compares the actual developer supply amount that has been adjusted by the adjusting section 56 with the ideal development supply amount and outputs the second comparison information.

If the difference between the ideal developer supply amount and the adjusted actual developer supply amount indicated in the second comparison information is greater than the specific amount set as the threshold value (Yes in Step S15), the routine proceeds to Step S16.

If the difference between the ideal developer supply amount and the adjusted actual developer supply amount indicated in the second comparison information is no greater than the specific amount set as the threshold value (No in Step S15), the routine repeats Step S15.

If Yes in Step S15 the adjusting section 56 adjusts the actual developer supply amount of the developer supply section 52 based on the second comparison information so as to change the ratio of the developer to the carrier (adjustment of the target T/C). The routine ends then.

An embodiment of the present disclosure has been described so far with reference to the drawings. However, the present disclosure is not limited to the above embodiment and can be implemented in various manners within a scope not departing from the gist thereof. The drawings may schematically illustrate elements of configuration in order to facilitate understanding. Aspects such as the number of each element of configuration illustrated in the drawings may differ from reality in order to facilitate preparation of the drawings. Furthermore, each element of configuration indicated in the above embodiment is an example and not a particular limitation. Various alterations may be made so long as there is no substantial deviation from the effects of the present disclosure.

What is claimed is:

1. An image forming apparatus comprising:
a development device that develops an electrostatic latent image formed on a photosensitive member with a developer;
a power source that applies a voltage to the development device;
storage that stores therein a printing rate and an ideal developer supply amount of the developer to be supplied to the development device, the ideal developer supply amount being determined according to the printing rate;
a developer supply section that supplies the developer to the development device;
a developer amount detection section that detects an amount of the developer in the development device;
a supply amount detection section that detects an actual developer supply amount by detecting an amount of the developer supplied by the developer supply section;
a comparison section that performs comparison of the actual developer supply amount with the ideal developer supply amount and outputs first comparison information indicating a result of the comparison; and
an adjusting section that adjusts based on the first comparison information the voltage that the power source applies.

2. The image forming apparatus according to claim 1, wherein
the comparison section compares the actual developer supply amount with the ideal developer supply amount at a time when a job ends, and outputs the first comparison information.

3. The image forming apparatus according to claim 1, wherein
the adjusting section adjusts the voltage only when the first comparison information indicates that a difference between the ideal developer supply amount and the actual developer supply amount is greater than a specific value.

4. The image forming apparatus according to claim 1, wherein
the comparison section performs additional comparison of the actual developer supply amount after the adjusting section adjusts the voltage with the ideal developer supply amount, and outputs second comparison information indicating a result of the additional comparison, and
the adjusting section further adjusts the actual developer supply amount of the developer supply section based on the second comparison information so as to change a ratio of the developer to a carrier.

5. The image forming apparatus according to claim 4, wherein
the adjusting section adjusts the actual developer supply amount only when the first comparison information indicates that a difference between the ideal developer supply amount and the actual developer supply amount is greater than a specific value.
